(19) United States
(12) Patent Application Publication
(10) Pub. No.: US 2008/0030988 A1
(43) Pub. Date: Feb. 7, 2008

(54) Controlling parking lighting

(76) Inventor: James Thor Williams, Tuckahoe, NY (US)

Correspondence Address: MORRISON & FOERSTER LLP, 425 MARKET STREET, SAN FRANCISCO, CA, 94105-2482, US

(21) Appl. No.: 11/890,932

(22) Filed: Aug. 7, 2007

Related U.S. Application Data
(60) Provisional application No. 60/836,256, filed on Aug. 7, 2006.

(51) Int. Cl. F21V 25/00

(52) U.S. Cl. 362/234

(57) ABSTRACT

A lighting control system to control parking lot lighting during off hours includes a wireless remote module, a wireless base module, and a control unit. The wireless remote module is installed in each light tower of a set of light towers in a parking lot. Each light tower has a set of light bulbs. The wireless remote module includes an antenna and a set of switches. Each light bulb in the set of light bulbs is connected to a switch in the set of switches. The wireless base module is configured to communicate wirelessly with each wireless remote module. The control unit is configured by a computer-readable storage medium having computer-executable instructions to communicate with the wireless base module. The control unit is configured to send instructions to the wireless remote modules through the base transceiver to individually control light bulbs in the light towers.

### CROSS-REFERENCE TO RELATED APPLICATION

This application claims the benefit under 35 USC 119(e) of prior copending U.S. Provisional Patent Application No. 60/836,256, filed Aug. 7, 2006, the disclosure of which is hereby incorporated by reference in its entirety.

### BACKGROUND

1. Field

The present application relates to parking lot lighting, and, more particularly, to wirelessly controlling individual light bulbs in a set of light bulbs in parking lot light towers.

2. Description of the Related Art

Parking lots provide areas for customers or employees, for example, to park their cars. It is common in communities for a business or place of work to provide the convenience of a parking lot. For example, it is not uncommon for people to drive their cars to their place of work, a doctor's office, the grocery store, etc. Proper lighting in parking lots is an important safety precaution. Sufficient lighting in parking lots may prevent assaults or tripping on unseen obstacles. After the sun goes down each day, parking lots are designed to provide a sufficient amount of lighting on the ground, typically defined by local building code ordinances, so that people moving to and from their cars can see their way through the parking lot.

However, a large majority of these parking lots are practically empty after normal business operating hours. During this time, parking lots are generally still fully illuminated, consuming the same amount of energy even though the need for safety has dramatically diminished. Due to the ever increasing cost of energy, commercial property owners and tenants are incurring a greater expense to light their parking lot facilities even though their building is empty during the middle of the night.

Therefore, a lighting control system that allows building owners to control the light bulbs in light towers in order to control parking lot lighting during off hours is desired. The building manager can easily control the number of hours each light bulb is utilized during the night, which reduces energy consumption and operating cost.

### SUMMARY

In one exemplary embodiment, a lighting control system to control parking lot lighting during off hours includes a wireless remote module, a wireless base module, and a control unit. The wireless remote module is installed in each light tower of a set of light towers in a parking lot. Each light tower has a set of light bulbs. The wireless remote module includes an antenna and a set of switches. Each light bulb in the set of light bulbs is connected to a switch in the set of switches. The wireless base module is configured to communicate wirelessly with each wireless remote module. The control unit is configured by computer-executable instructions from a computer-readable storage medium to communicate with the wireless base module. The control unit is configured to send instructions to the wireless remote modules through the base module to individually control light bulbs in the light towers.

For example, a light tower with four light bulbs can be configured so that after all business has ceased in the building, only one of the light bulbs of the set of light bulbs on the light tower will be switched on at a given time. After a predetermined amount of time, 2 hours for example, the light bulb that was on will be switched off and another light bulb in the light tower will be switched on.

### DESCRIPTION OF THE FIGURES

FIG. 1A depicts a top view perspective of an exemplary lighting control system to control parking lot lighting;

FIG. 1B depicts a side view perspective of an exemplary lighting control system to control parking lot lighting;

FIG. 2A depicts a top view perspective of an exemplary embodiment of a wireless remote module connected to embodiments of parking lot light towers;

FIG. 2B depicts a side view perspective of an exemplary embodiment of a wireless remote module connected to a parking lot light tower;

FIG. 2C depicts an exemplary block diagram of an embodiment of a wireless remote module connected to a parking lot light tower;

FIG. 3 depicts an exemplary embodiment of a wireless base module;

FIG. 4 depicts an exemplary embodiment of a control unit;

FIG. 5 depicts an exemplary embodiment of the organizational structure of a user interface of the control unit;

FIG. 6 depicts an exemplary flowchart of control instructions used to control parking lot lighting; and

FIG. 7 depicts an exemplary control sequence used to control parking lot lighting.

### DETAILED DESCRIPTION

In order to provide a more thorough understanding of the present invention, the following description sets forth numerous specific details, such as specific configurations, parameters, examples, and the like. It should be recognized, however, that such description is not intended as a limitation on the scope of the present invention, but is intended to provide a better description of the exemplary embodiments.

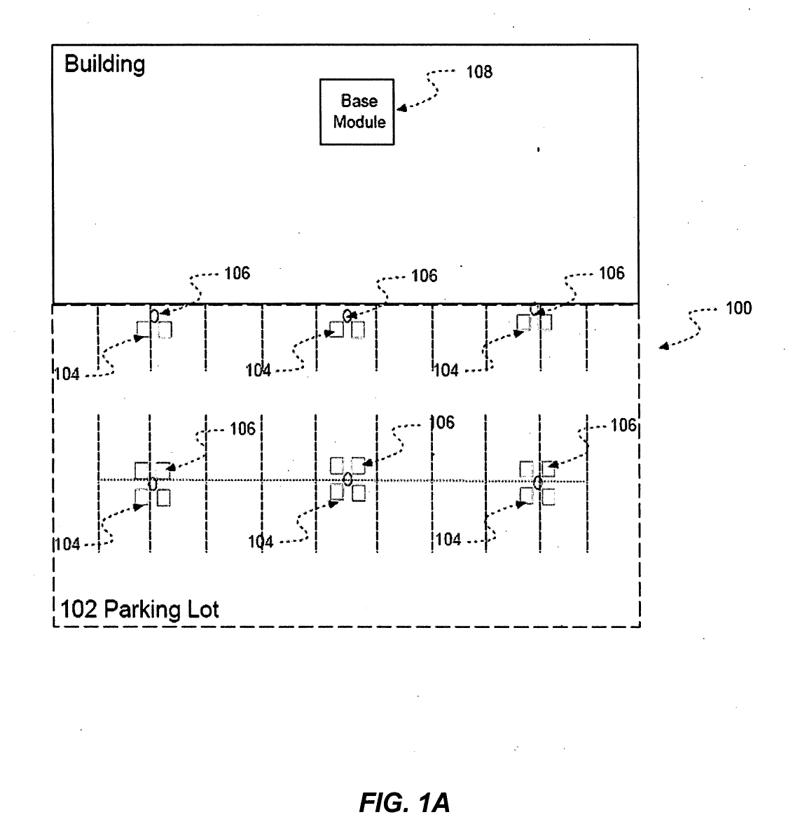

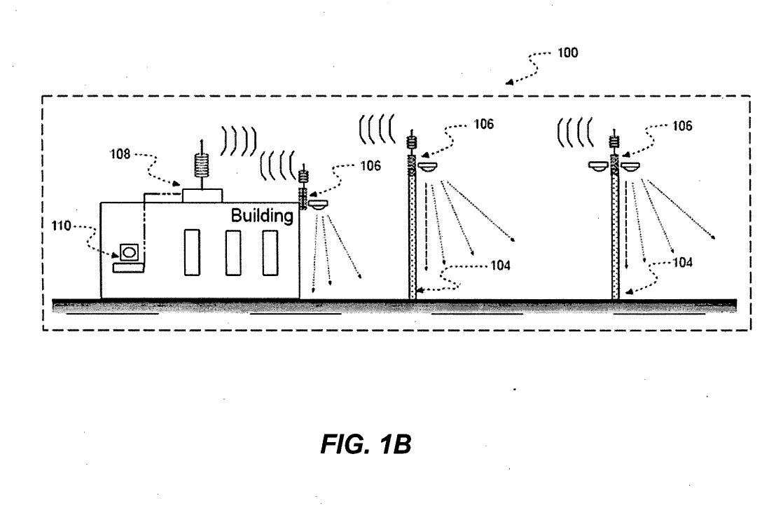

With reference to FIG. 1A, an exemplary embodiment of a lighting control system 100 to control parking lot lighting is depicted from a top view perspective. FIG. 1B depicts an exemplary embodiment of the lighting control system from a side view perspective. Parking lot 102 includes a plurality of light towers 104 that are used to illuminate the parking lot when ambient light level is low. A light tower 104 contains a set of light bulbs. As depicted in FIG. 1B, lighting control system 100 includes a wireless remote module 106, a wireless base module 108, and a control unit 110. The control unit 110 includes a computer-readable storage medium having computer executable instructions. In a preferred embodiment, lighting control system 100 is an easily installed add-on to existing parking lot light towers. Controlling lighting in a parking lot by individually controlling light bulbs in light towers throughout off-hours can reduce energy consumption by as much as 75%, provide automatic control, provide flexibility in control, reduce light pollution in the community, and maintain security and safety.

The wireless remote modules 106 are installed on light towers 104. It should be recognized that a wireless remote module 106 can be installed on each light tower 104 in parking lot 102. Alternatively, wireless remote modules 106 can be installed only on some of the light towers 104 in parking lot 102. As will be described below in more detail, a wireless remote module 106 is connected to light bulbs in a light tower 104 to individually control the light bulbs.

The wireless base module 108 is preferably located in a low-interference area proximal to the parking lot 102, such as on a building rooftop. The control unit 110 can be installed in a location convenient to the user, such as a building management's computer. As depicted in FIG. 1B, the control unit 110 communicates with the wireless base module 108, which then communicates with wireless remote modules 106 on light towers 104. In particular, instructions from the control unit 110 are transmitted to the wireless base module 108. The wireless base module 108 then wirelessly transmits the instructions to the appropriate wireless remote module 106 installed on a light tower 104 in the parking lot 102 to individually control the set of light bulbs on the light tower 104.

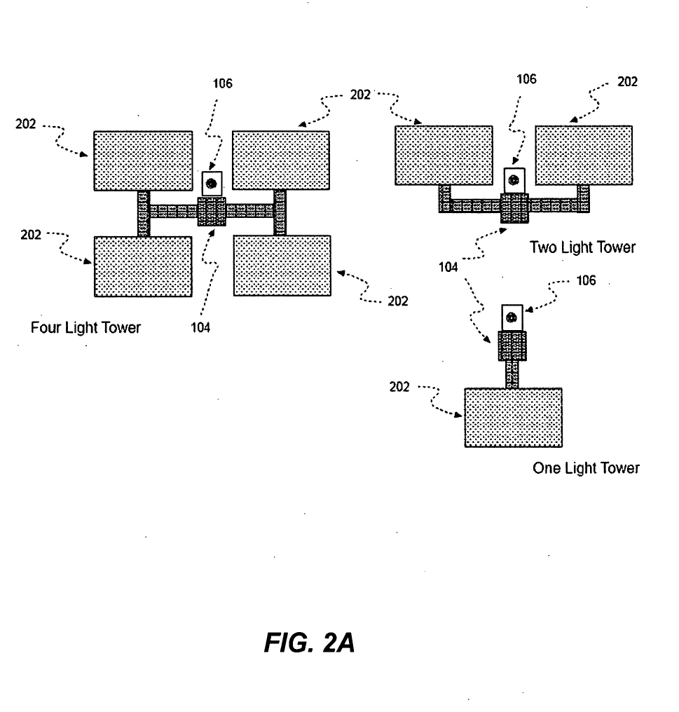

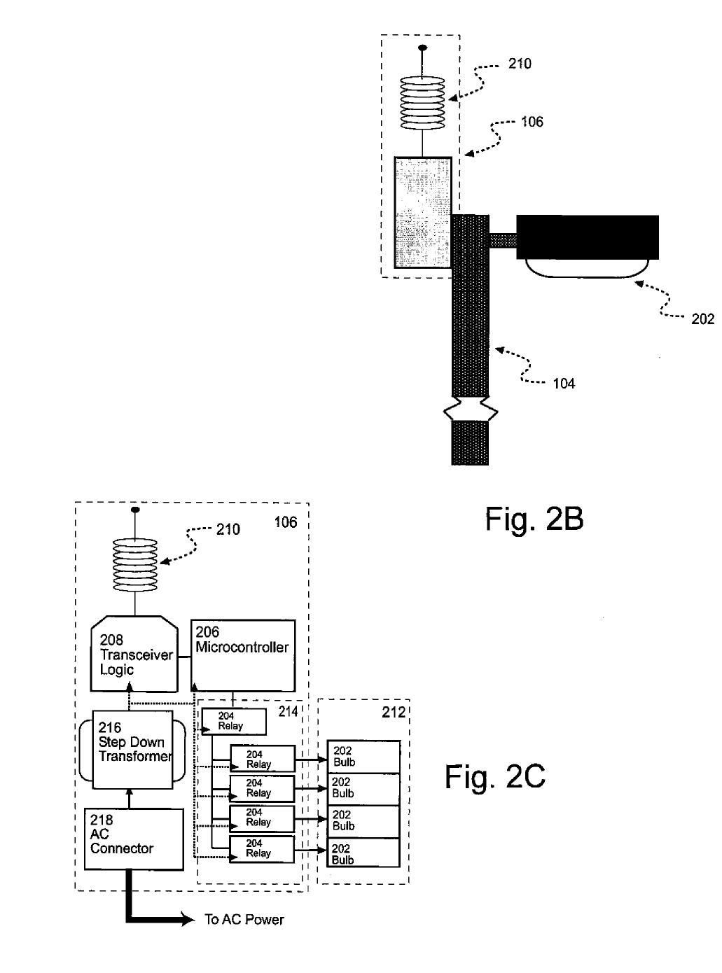

With reference to FIG. 2A, perspective top views of embodiments of a light tower in different light bulb configurations are depicted. Wireless remote module 106 is installed on light tower 104. The light tower 104 may be configured in several configurations of light bulbs 202. For example, as depicted, a light tower 104 may be configured with four light bulbs, three light bulbs (not shown), two light bulbs, or one light bulb.

With reference to FIG. 2B, a perspective side view of an embodiment of a light tower is depicted. A remote module 106, including an antenna 210, is installed on light tower 104. The remote module 106 controls the light bulb 202 of the light tower 104.

With reference to FIG. 2C, an exemplary embodiment of the wireless remote module 106 installed on a light tower 104 is depicted in more detail. The wireless remote module 106 includes switches 214, control logic 206, transceiver logic 208, an antenna 210, a step down transformer 216, and an AC connector 218. Each switch 214 includes a relay 204 for each bulb. The step down transformer 216 and AC connector 218 may be used to conveniently power the wireless remote module 106. The modularity of the wireless remote module 106 permits easy retrofitting onto existing light towers. The wireless remote module 106 can also be pre-installed in the light tower by its manufacturer.

The antenna 210 and transceiver logic 208 receive the instructions sent by wireless base module 108 (FIG. 1B). The transceiver logic 208 communicates the received instructions to control logic 206, which controls the set of switches 214. Each light bulb 202 in the set of light bulbs 212 in the light tower 104 is connected to a high voltage switch 204 in the set of switches 214 of the wireless remote module 106. Thus, an individual light bulb 202 can be turned on or off by a corresponding high voltage switch 204 according to the received instructions. In addition to executing the instructions from the control unit 110, the wireless remote module 106 can detect and transmit operational information to the control unit 110 (FIG. 1B) for management utilization.

It should be recognized that the set of light bulbs 212 connected to switch 214 can be only some of the light bulbs in light tower 104. For example, a light tower 104 can have six light bulbs. Only four of the six light bulbs may be connected to high voltage relay switches 204 in the set of switches 214. Thus, in this example, the set of lights bulbs 212 only include the four light bulbs connected to high voltage switches 204 in the set of switches 214.

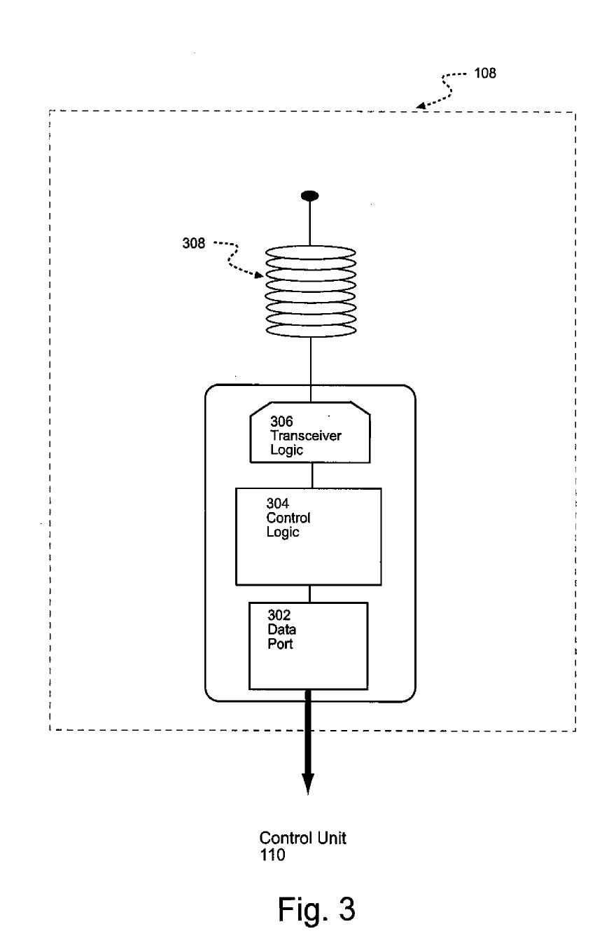

With reference to FIG. 3, an exemplary embodiment of the wireless base module 108 is depicted in more detail. The wireless base module 108 includes a data port 302, control logic 304, transceiver logic 306, and an antenna 308. The wireless base module 108 receives instructions from the control unit 110 (FIG. 1B) through a hard wire connection through the data port 302 and control logic 304. Instructions are transmitted to appropriate wireless remote modules 106 (FIG. 1B) through transceiver logic 306 and antenna 308. Wireless base module 300 can also receive operational information transmitted from wireless remote modules 106 (FIG. 1B) through antenna 308 and transceiver logic 306. The operational information is then sent to the control unit 110 through control logic 304 and data port 302.

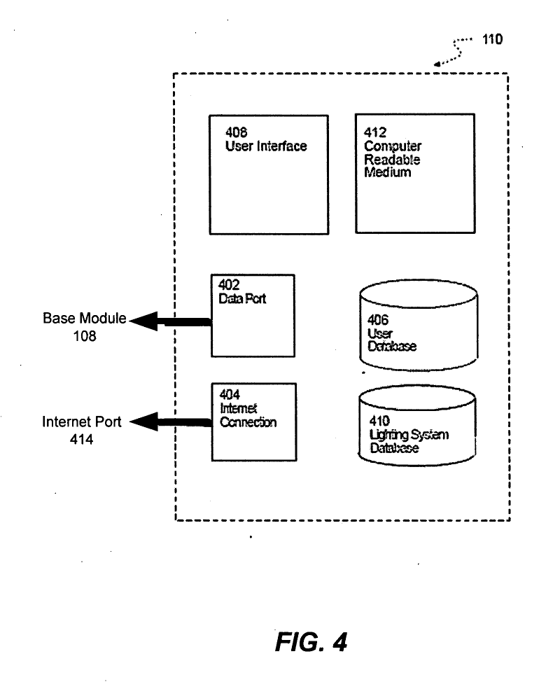

With reference to FIG. 4, an exemplary embodiment of the control unit 110 is depicted in more detail. The control unit 110 allows a user, in part, to configure the instructions, establish and store the authorized user accounts with passwords, and store and utilize operational information in service and maintenance of the parking lot light towers. The control unit 110 can be a personal computer with an operating system, such as Microsoft Windows, Apple MacOS, or Linux.

The control unit 110 comprises a computer-readable storage medium 412 having computer-executable instructions, and provides a user interface 408 for a user to input instructions or view operational information to control the lighting in the parking lot. The user interface 408 utilizes graphics and icons. The user interface 408 allows the user to configure instructions to set the on/off times for each light bulb in the parking lot lighting system. Access to the user interface 408 can be limited to authorized users. Authorized user information, user name and password, are stored in a user database 406.

Instructions are sent to the wireless base module 108 (FIG. 1B), or operational information is received from the wireless base module 108 (FIG. 1B), through a data port 402. A lighting system database 410 stores the operational information, such as usage of each light bulb, light bulb failures, and instances when the light bulbs were tuned on by a user through the control unit 110, or manually.

The computer-readable storage medium has computer-executable instructions to send the instructions to individually control light bulbs in at least one light tower. The instructions are sent to the wireless remote modules through the wireless base module. The computer-readable storage medium has computer-executable instructions also to receive and analyze operational information received from a wireless remote module through the wireless base module.

In an exemplary embodiment, the control unit 110 incorporates remote access into the parking lot lighting control system through a secure internet connection 404. The secure internet connection 404 to an internet port 414 provides an internet or cellular phone link that enables authorized users to manually override the control system software or adjust the lighting pattern in the parking lot from a remote location. Remote access provides users with the ability to control the parking lot lighting control system from any location with internet access. Additionally, the internet-based access can be configured so that emergency service personnel (police, fire, paramedics, etc.) can use any internet-enabled wireless device (cell phone, PDA, etc.) to turn on all of the light bulbs controlled by the parking lot lighting control system during emergencies.

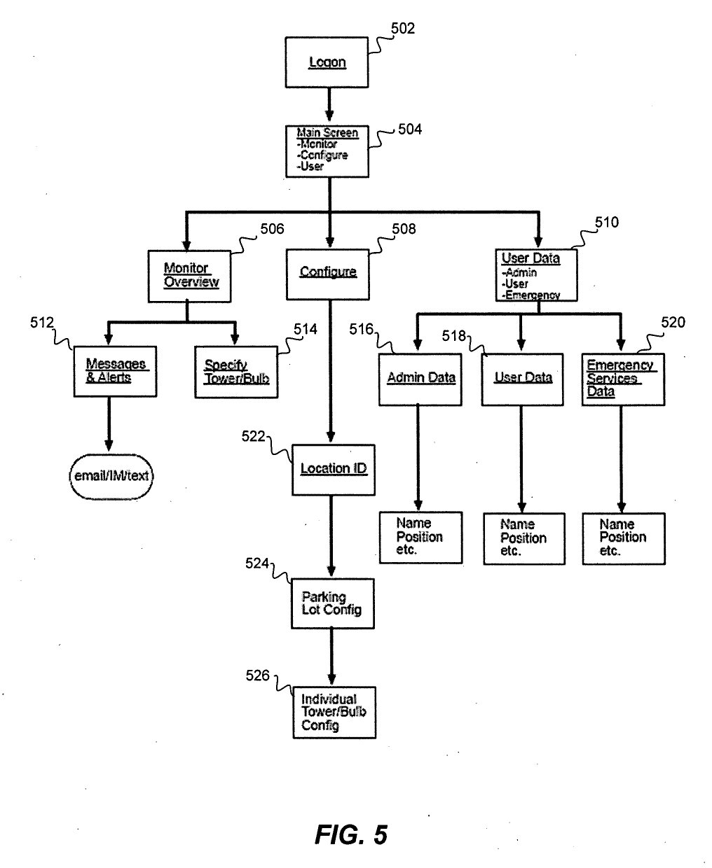

With reference to FIG. 5, an exemplary diagram of organizational structure of a user-interface for a control unit is depicted. To access the user-interface, the user enters in a logon ID 502. After the user is authorized, the user-interface provides a main screen of categories for functions for the user to access. The categories 504 include monitor, configure, and user. Monitor functions 506 allow the user to view messages and alerts 512, and to specify specific light towers/bulbs 514 for viewing the status. For example, the user may view if a specific bulb is in an on/off state, or if the bulb is functional. The user may choose the configure menu 508, which will prompt the user to enter in a location ID 522. After entering in a location ID 522, the user may choose a parking lot configuration 524, and subsequently be allowed to configure individual light towers/bulbs 526. Accessing the user data functions 510 will allow the user to configure administrative data 516, user data 518, and emergency services data 520.

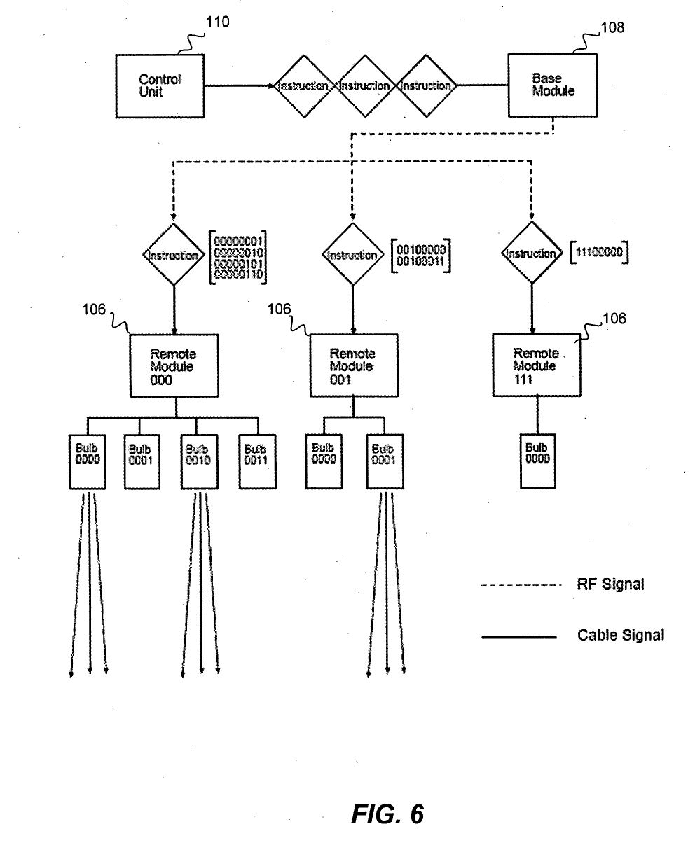

With reference to FIG. 6, an exemplary embodiment of communication in the lighting control system is depicted. The control unit 110 sends instructions for specific remote modules of light towers to the base module 108. The base module 108 wirelessly transmits instructions to the specified remote module 106. The instructions include configuration instructions for the light bulbs controlled by remote module 106. In particular, the configuration instructions include the instructions to control the on/off state of each light bulb of the set of light bulbs controlled by the remote module.

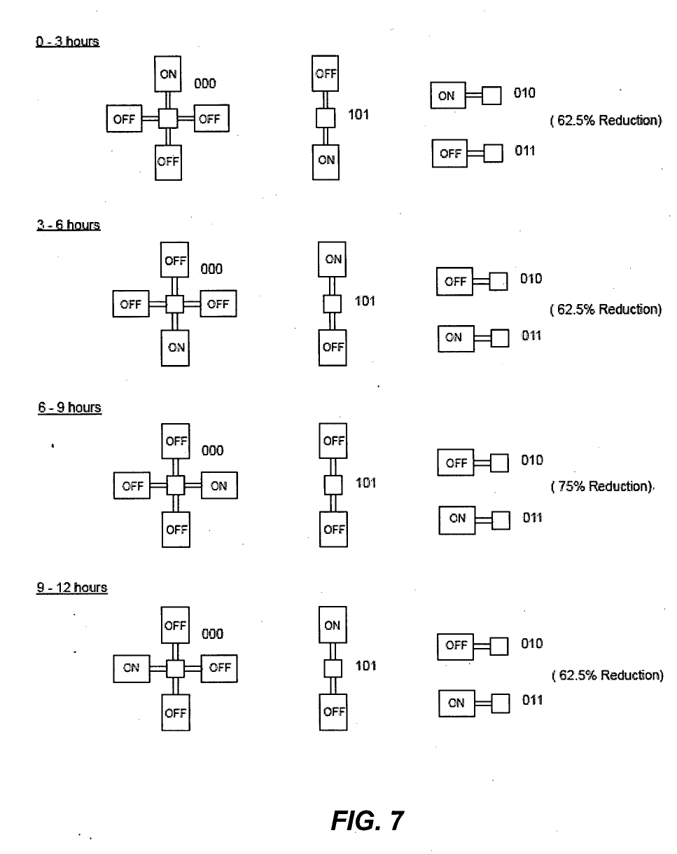

With reference to FIG. 7, an exemplary embodiment of a light sequence of on/off states is depicted for a set of parking lot light towers. The set of light towers includes a four bulb light tower, two bulb light tower, and 2-one bulb light towers. The sequence includes 3-hour time intervals. During the 0-3 hour interval, five of the eight total bulbs of the set of light towers are in an off-state, resulting in a 62.5% reduction of light. Similarly, in the 3-6 hour interval, five of the eight total bulbs in the set of light towers are in an off-state also resulting in a 62.5% reduction of light. However, bulbs that may have been in an on-state in the 0-3 hour interval may be in an off-state. During the 6-9 hour interval, six of the eight total bulbs of the set of light towers are in an off-state, resulting in a 75% reduction of light. The last interval of the sequence, 9-12 hour interval, has again five of the eight total bulbs in an off-state for a 62.5% reduction of light. In this exemplary light sequence, the light level is reduced and different sets of on-state bulbs are adjusted for certain time intervals. Energy and bulb life may be conserved.

In order for the parking structure to maintain the same safe and secure environment during the night, the parking lot lighting control system can ensure that a sufficient light level is maintained. This can enable security services to visually see into all parts of the parking lot and identify unauthorized usage. If the control unit were to fail, the default light configuration is for all of the light bulbs in the parking lot to turn on. Only when the control unit is functioning properly can light bulbs in the light towers be turned off during the night.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching.

We claim:

1. A lighting control system to control parking lot lighting during off hours, the system comprising:
a set of light towers, each light tower having a set of light bulbs;
connected to each light tower, a wireless remote module,
wherein the wireless remote module comprises:
an antenna; and
a set of switches, wherein each light bulb in the set of light bulbs is connected to a switch in the set of switches;
a wireless base module configured to communicate wirelessly with each wireless remote module; and
a computer-readable storage medium encoded with computer-executable instructions to communicate with the wireless base module, the instructions comprising:
sending instructions to individually control light bulbs in at least one light tower with the set of light switches, wherein the instructions are sent to the wireless remote module through the wireless base module.

2. The lighting control system of claim 1, wherein the wireless remote module further comprises:
a transceiver logic connected to the antenna; and
a control logic connected to the set of switches.

3. The lighting control system of claim 2, wherein the wireless remote transceiver is retrofitted on a light tower.

4. The lighting control system of claim 2, wherein the wireless remote module transmits operational information from each light bulb in the set of light bulbs in the light tower.

5. The lighting control system of claim 1, wherein the wireless base module comprises:
a data port;
a control logic connected to the data port;
an antenna; and
a transceiver logic connected to the antenna.

6. The lighting control system of claim 1, further comprising a control unit, wherein the control unit comprises:
the computer readable storage medium encoded with computer-executable instructions;
a user interface;
a data port;
a secure internet connection;
a user database having authorized user information stored thereon; and
a lighting system database having operational information stored thereon.

7. The lighting control system of claim 1, wherein the computer-executable instructions, further comprises instructions for receiving operational information.

8. The lighting control system of claim 6, wherein the operational information includes light bulb usage time.

9. The lighting control system of claim 6, wherein the operational information is light bulb failure.

10. The lighting control system of claim 1, wherein the instructions to individually control each light bulb comprises turning on one light bulb in the set of light bulbs for a predetermined amount of time.

11. A lighting control system to control parking lot lighting during off hours, the system comprising:
a set of wireless remote modules, wherein the set of wireless remote modules are configured to be retrofitted onto a set of light towers in a parking lot, each wireless remote module comprising:
an antenna; and
a set of switches, wherein each switch in the set of switches is configured to be connected to an individual light bulb in a set of light bulbs on a light tower in the set of light towers;
a wireless base module configured to communicate wirelessly with each wireless remote module; and
a computer-readable storage medium encoded with computer-executable instructions to communicate with the wireless base module, the instructions comprising:
sending instructions to individually control light bulbs in at least one light tower with the set of light switches, wherein the instructions are sent to the wireless remote module through the wireless base module.

12. The lighting control system of claim 11, wherein the wireless remote module further comprises:
a transceiver logic connected to the antenna; and
a control logic connected to the set of switches.

13. The lighting control system of claim 11, wherein the wireless base module comprises:
a data port;
a control logic connected to the data port;
an antenna; and
a transceiver logic connected to the antenna.

14. The lighting control system of claim 11, further comprising a control unit, wherein the control unit comprises:
the computer-readable storage medium encoded with computer-executable instructions;
a user interface;
a data port;
a secure internet connection;
a user database having authorized user information stored thereon; and
a lighting system database having operation information stored thereon.

15. A method of controlling parking lot lighting during off hours, the method comprising:
transmitting instructions from a computer readable storage medium encoded with computer-executable instructions to a wireless base module, the instructions comprising:
sending instructions to individually control light bulbs in at least one light tower with the set of light switches, wherein the instructions are sent to the wireless remote module through the wireless base module;
transmitting the instructions wirelessly from the wireless base module to at least one wireless remote module installed on a light tower of a parking lot; and
at the at least one wireless remote module,
receiving the instructions using an antenna in the wireless remote module; and
controlling individually light bulbs in a set of light bulbs on the light tower using a set of switches in the wireless remote module in response to the received instructions, wherein each light bulb in the set of light bulbs is connected to a switch in the set of switches.

16. The method of claim 15, wherein a control unit comprises the computer-readable storage medium having computer-executable instructions.

17. The method of claim 16, further comprising:
transmitting operational information about each light bulb in the set of light bulbs in the light tower from the wireless remote module to the wireless base module;
transmitting the operational information from the wireless base module to the control unit;
receiving the operational information at the control unit; and
analyzing the received operational information at the control unit.

18. The method of claim 17, wherein a control unit comprises the computer-readable storage medium encoded with computer-executable instructions, the instructions comprising:
receiving instructions to receive operational information; and
processing instructions to analyze the operational information.

19. The method of claim 17, wherein the operational information includes light bulb usage time.

20. The method of claim 17, wherein the operational information includes light bulb failure.

21. The method of claim 15, wherein the instructions include turning on one light bulb in the set of light bulbs for a predetermined amount of time.

22. A method of retrofitting a lighting control system to control parking lot lighting during off hours onto a set of light towers in a parking lot, the method comprising:
installing a set of wireless remote modules, wherein each wireless remote module is installed onto one light tower in the set of light towers, and wherein each wireless remote module comprises:
an antenna; and
a set of switches;
at each light tower, connecting each switch in the set of switches of the wireless remote module to an individual light bulb in a set of light bulbs on the light tower;
installing a wireless base module configured to communicate wirelessly with each wireless remote module; and
installing a computer-readable storage medium encoded with computer-executable instructions to communicate with the wireless base module, the instructions comprising:
sending instructions to individually control light bulbs in at least one light tower with the set of light switches, wherein the instructions are sent to the wireless remote module through the wireless base module.
